(19) United States
(12) Patent Application Publication
(10) Pub. No.: US 2020/0050503 A1
(43) Pub. Date: Feb. 13, 2020

(54) METHODS FOR RESOLVING DIFFERENT MESSAGE DATA BLOCK FORMATS BETWEEN COMPUTER PROGRAM INSTANCES AND RELATED SYSTEMS AND COMPUTER PROGRAM PRODUCTS

(71) Applicant: CA, Inc., New York, NY (US)

(72) Inventors: Paul Hinkley, Lombard, IL (US); Jordan Hisey, Schaumburg, IL (US); Mark Linker, Oswego, IL (US); John C. Tucker, Downers Grove, IL (US)

(21) Appl. No.: 16/102,586

(22) Filed: Aug. 13, 2018

(51) Int. Cl. G06F 9/54; H04L 9/32; H04L 29/06

(52) U.S. Cl. CPC G06F 9/546; G06F 9/541; G06F 2209/547; H04L 63/123; H04L 9/3236

(57) ABSTRACT

A method includes performing, by a processor: receiving a message, a message identification, and a hash value of a map specifying a layout of the message, comparing the hash value with a reference hash value associated with the message identification, requesting the map responsive to a mismatch between the hash value and the reference hash value, receiving the map, and decoding the message based on the map.

### BACKGROUND

The present disclosure relates to computer systems, and, in particular, to methods, systems, and computer program products for managing software instances in a multi-level software deployment environment.

An enterprise may have numerous computer systems that execute a software application. Enterprises with large installations, for example, may have many instances of a software application running on different computer systems. These various instances communicate with each other by exchanging data in the form of messages. Some software applications are designed to exchange messages in the form of a block of data. The sending and receiving instances of the software application must be in agreement on the meaning of each byte within the data block. Software application instances on different release and/or maintenance levels, however, may structure the layout of the data in the message data block differently, which may result in a loss of communication between one or more computer systems in an enterprise.

### SUMMARY

In some embodiments of the inventive subject matter, a method comprises performing by a processor: receiving a message, a message identification, and a hash value of a map specifying a layout of the message, comparing the hash value with a reference hash value associated with the message identification, requesting the map responsive to a mismatch between the hash value and the reference hash value, receiving the map, and decoding the message based on the map.

In other embodiments of the inventive subject matter, a system comprises a processor and a memory coupled to the processor and comprising computer readable program code embodied in the memory that is executable by the processor to perform operations comprising: receiving a message, a message identification, and a hash value of a map specifying a layout of the message, comparing the hash value with a reference hash value associated with the message identification, requesting the map responsive to a mismatch between the hash value and the reference hash value, receiving the map, and decoding the message based on the map. The map identifies a plurality of fields in the message and further identifies, for each of the plurality of fields, a field name and a plurality of field attributes. The map is a first map and is associated with a first computer program level and the reference hash value is of a reference map associated with a second computer program level that is different from the first computer program level.

In further embodiments of the inventive subject matter, a computer program product comprises a tangible computer readable storage medium comprising computer readable program code embodied in the medium that is executable by a processor to perform operations comprising: receiving a message, a message identification, and a hash value of a map specifying a layout of the message, comparing the hash value with a reference hash value associated with the message identification, requesting the map responsive to a mismatch between the hash value and the reference hash value, receiving the map, and decoding the message based on the map.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a system for deploying software across multiple computer systems in accordance with some embodiments of the inventive subject matter;

FIG. 2 is a block diagram that illustrates the generation of a data map for resolving different data block formats between software instances according to some embodiments of the inventive subject matter;

FIG. 3 is a block diagram that illustrates a data processing system that may be used to implement the computer systems that are configured to execute the different software instances of FIG. 1 in accordance with some embodiments of the inventive subject matter;

FIG. 4 is a block diagram that illustrates a software/hardware architecture for resolving different data block formats between software instances in accordance with some embodiments of the inventive subject matter; and

FIGS. 5-7 are flowcharts that illustrate operations for resolving different data block formats between software instances in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

As used herein, the term “level” as applied to a software application, a computer program, or the like, (hereinafter “computer program”) refers to assigning a unique name, number, or other identifier (e.g., combination of name and number) to identify a unique state of the computer program. Different “levels” of a software application or computer program may refer to any differences between the software application or computer program including changes resulting from different versions, different releases, maintenance updates, program patches or fixes, and the like.

As used herein, the term “message” means a unit of information and/or a block of data that may be transmitted electronically as a whole or via segments from one device to another. Accordingly, as used herein, the term “message” may encompass such terms of art as “frame” and/or “packet,” which may also be used to refer to a unit of transmission.

As used herein, the term “data block” means a unit of information and/or a collection of data that may be organized using a defined format, such as a data structure, to facilitate access to the information and/or data. In accordance with various embodiments, data blocks may be communicated as part of a message, stored in volatile memory, and/or stored in non-volatile persistent memory

Some enterprises may have data processing facilities that include multiple computer systems, servers, and/or mainframes, which are referred to generally herein as “computer systems.” These enterprises may have one or more computer programs that are spread across the different computer systems as multiple instances. When a new level of a computer program is made available, the new computer program level may be installed on the enterprise's computer systems that are running the computer program. There may be times, however, when an enterprise prefers not to update all computer systems running a particular computer program with a new level. When a new level results in a messaging data block format change and/or a change in a data block format that is maintained in persistent storage, however, computer systems running different instances of a computer program may in some circumstances be unable to communicate with each other due to an inability to parse a data block in a received message. Similarly, a data block saved in persistent storage using a first data structure arrangement may not be accessible to subsequent computer program levels that use a different data structure arrangement for the data block. Some embodiments of the inventive subject matter stem from a realization that, for each type of message or data block, a data map may be created that includes the fields and attributes of each field so as to fully describe the data block used to implement the particular message type or data block type. A hash value may be generated based on the data map. When a computer program instance sends a message from one computer system to another computer system, for example, it may include a hash value associated with the particular message type or identification. A receiving computer program instance compares a reference hash value stored locally for the particular message type or message identification with the received hash value. If they are the same, then the sending computer program instance and the receiving computer program instance are using the same data block format for this particular message type or message identification. If the hash values are different, however, then the two computer program instances are using different data block formats for this particular message type or identification. The receiving computer program instance then requests the data map for this particular message type or identification from the sending computer program instance and uses the received data map to parse/decode the message. The receiving computer program instance may then save the received data map along with the hash value associated therewith so that future communication with computer systems running a computer program instance that uses this message format may be performed without the need to request the data map. Similarly, a software application associated with a first level may store a block of data, such as a file, for example, in persistent storage using a first data structure format. At a later time, which could range from minutes to years, the software application may be changed so as to have a different level that uses a second data structure format for the block of data in persistent storage. The software application may compare its own hash value corresponding to the second data structure format with the hash value associated with the first data structure format stored in persistent storage. If the hash values do not match, then the software application may access the data map associated with the block of data in persistent storage allowing the software application to decode the first data structure format.

Embodiments of the inventive subject matter may, therefore, provide a mechanism for an enterprise to install new levels of computer programs on its computer systems on a selective basis according to the enterprise's own schedule as opposed to being required to install new software on all computer systems running a particular computer program at the same time. Moreover, embodiments of the inventive subject matter make use of a hash value of a data map that can be included when a message is sent from one computer system to another computer system and used to determine whether the receiving computer system can parse or decode the received message. Only when the receiving computer system does not have a stored data map with a hash value matching the received hash value does the receiving computer system request the data map from the sending computer system. By avoiding transmitting the data map between computer systems running different computer program instances, except when it is necessary, the impact on communication resources, such as bandwidth, transmit/receive buffers, and the like, along with processing resources may be reduced while still allowing the different computer program instances to communicate. In addition, a data block that is stored in persistent data storage may have a data map associated therewith that can be used to decode the data block even though new computer program instances may use a different format or structure for the same data block.

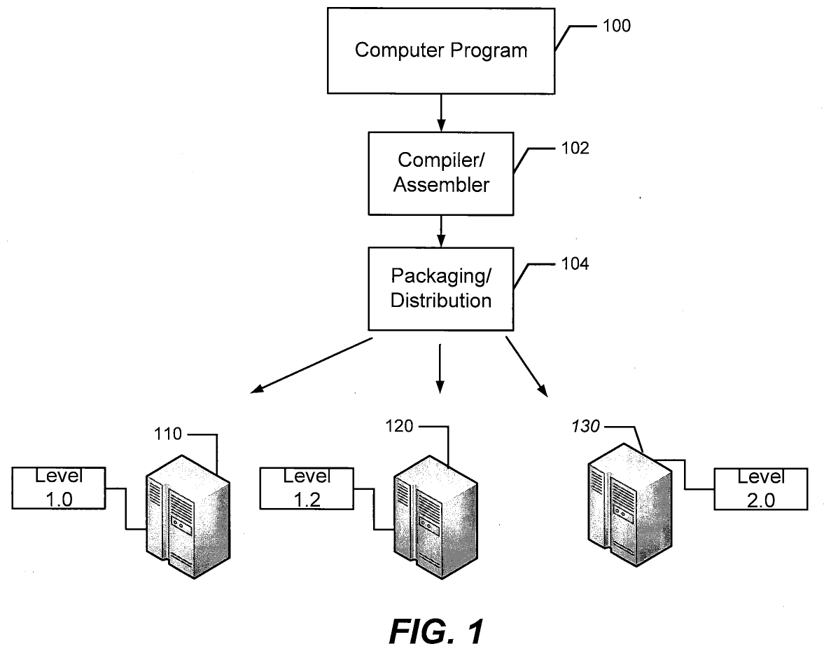

FIG. 1 is a block diagram that illustrates a system for deploying software across multiple computer systems in accordance with some embodiments of the inventive subject matter. An enterprise may have multiple computer systems, which each may comprise one or more data processing systems that are configured with a variety of different data processing facilities. Computer programs 100, including, but not limited to, application software, Operating System software, utilities, drivers, and the like, may be developed and installed in an enterprise's computer systems. As shown in FIG. 1, a computer program 100 may be written in a high-level language and then processed using a compiler and/or assembler 102 to generate the executable object code, which a packaging/distribution system 104 distributes to run on various data processing systems 110, 120, and 130. As described above, traditionally, an enterprise would update all computer systems so as to have the same version to reduce the risk that various computer systems and/or data processing systems would not be able to process messages from another system running a different version of the computer program. As will be described in detail herein, the compiler/assembler 102, according to some embodiments of the inventive subject matter, may be configured to cooperate with a data map generator/processor that facilitates the resolution of different message data block formats between computer program instances corresponding to different levels. Thus, even though computer systems and/or data processing systems 110, 120, and 130 are running different levels of a computer program, i.e., Level 1.0, Level 1.2, and Level 2.0, respectively, they may successfully communicate with each other despite using different formats for one or more messages and/or data blocks.

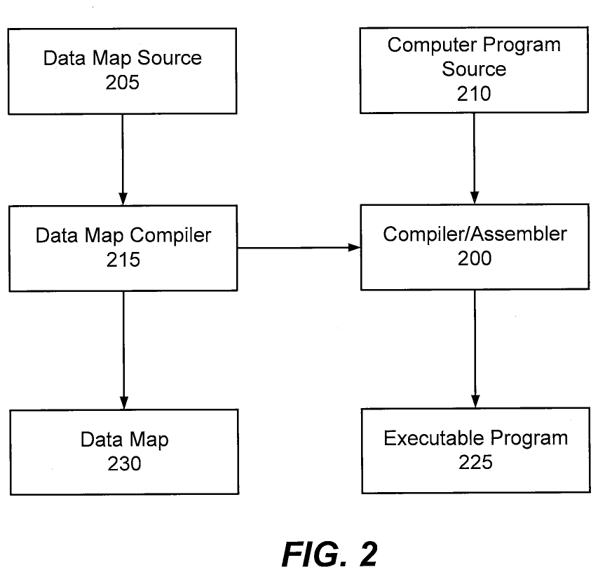

FIG. 2 is a block diagram that illustrates the generation of a data map for resolving different data block formats between software instances according to some embodiments of the inventive subject matter. A data map compiler 215 receives a data map source 205 (at least a portion of a computer program) for analysis. The data map compiler 215 is configured to generate code that defines a data map for each data block structure in the computer program 210. The data map is associated with an identification of each message containing a data block and further identifies or specifies each of the fields in the data block within message. Similarly, for data blocks stored in persistent storage, for example, the data map specifies each of the fields used in the data block. In some embodiments, each field is identified through a field name and one or more attributes. The attributes may include, but are not limited to, length, an offset within the message, a data format, a justification, pad bytes, and/or character encoding (e.g., ASCII, EBCDIC, UNICODE, etc.). The data map may further identify whether a field is repeating and, if so, a number of repetitions for the repeating field. The data map compiler 215 may be further configured to generate data block processing code that facilitates generation of a hash value for each data map and the communication of the hash value when transmitting a message. The data block processing code may facilitate reception and parsing of messages along with the associated hash values based on a comparison of hash values generated for one or more local data maps. The data block processing code may further facilitate requesting of a data map from the message originator when a receiving system cannot decode or parse the data map. Similarly, the data block processing code may facilitate the access of a data block in persistent storage based on a comparison of hash values generated for the data block stored in persistent storage and the same type of data block used by the current computer program level.

The compiler/assembler 200 receives the computer program source 210 for analysis. According to various embodiments, the computer program 210 is written in a high-level programming language that is ultimately compiled to generate executable object code for execution on one or more target computer systems and/or data processing systems. In other embodiments, the computer program 210 is written in assembly language, which can be assembled to generate the executable object code for execution on one or more target computer systems and/or data processing systems. The computer program 210 may also be written in an interpreted programming language or may be processed using a Just-In-Time compiler. The code generated by the data map compiler 215, including the hash value(s), may supplement the computer program 210, such that the computer program 210 and the code output from the data map compiler 215 are compiled together using the compiler/assembler 200 to generate an executable program 225 including the hash value(s). The data map compiler 215 may generate one or more data map(s) including hash values 230 for the various data block(s).

Although FIG. 2 illustrates an example system for generation of a data map for resolving different data block formats between software instances, it will be understood that embodiments of the present inventive subject matter are not limited to such configurations, but are intended to encompass any configuration capable of carrying out the operations described herein.

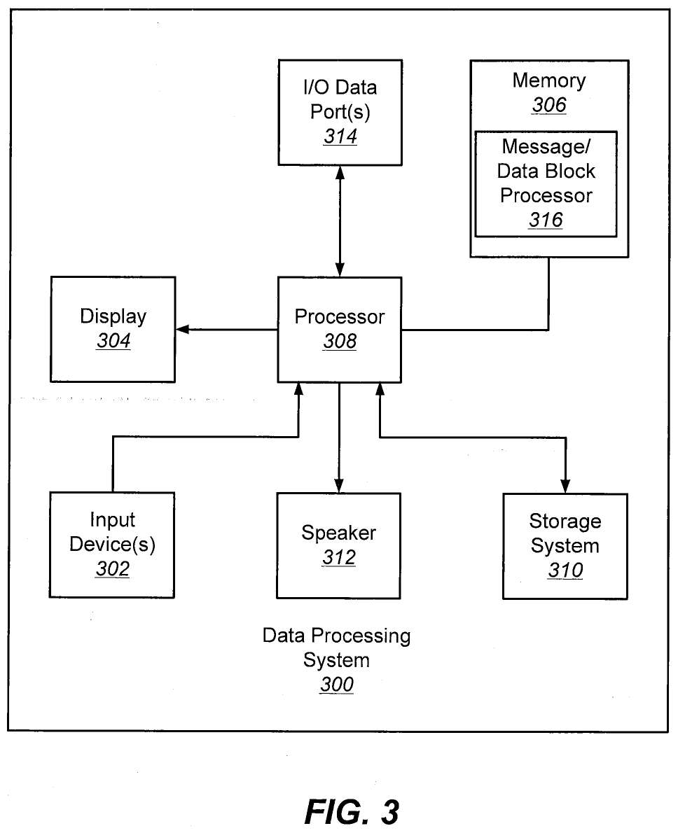

FIG. 3 is a block diagram that illustrates a data processing system that may be used to implement the computer systems that are configured to execute the different software instances of FIG. 1 in accordance with some embodiments of the inventive subject matter. Referring now to FIG. 3, a data processing system 300 that may be used to implement the computer systems and/or data processing systems 110, 120, 130 of FIG. 1, in accordance with some embodiments of the inventive subject matter, comprises input device(s) 302, such as a keyboard or keypad, a display 304, and a memory 306 that communicate with a processor 308. The data processing system 200 may further include a storage system 310, a speaker 312, and an input/output (I/O) data port(s) 314 that also communicate with the processor 308. The storage system 310 may include removable and/or fixed media, such as floppy disks, ZIP drives, hard disks, or the like, as well as virtual storage, such as a RAMDISK. The I/O data port(s) 314 may be used to transfer information between the data processing system 300 and another computer system or a network (e.g., the Internet). These components may be conventional components, such as those used in many conventional computing devices, and their functionality, with respect to conventional operations, is generally known to those skilled in the art. The memory 306 may be configured with a message/data block processor module 316 that may be configured to facilitate reception and parsing of data blocks, both as part of messages and/or in persistent storage, along with the associated hash values based on a comparison of hash values generated for one or more data maps according to some embodiments of the inventive subject matter.

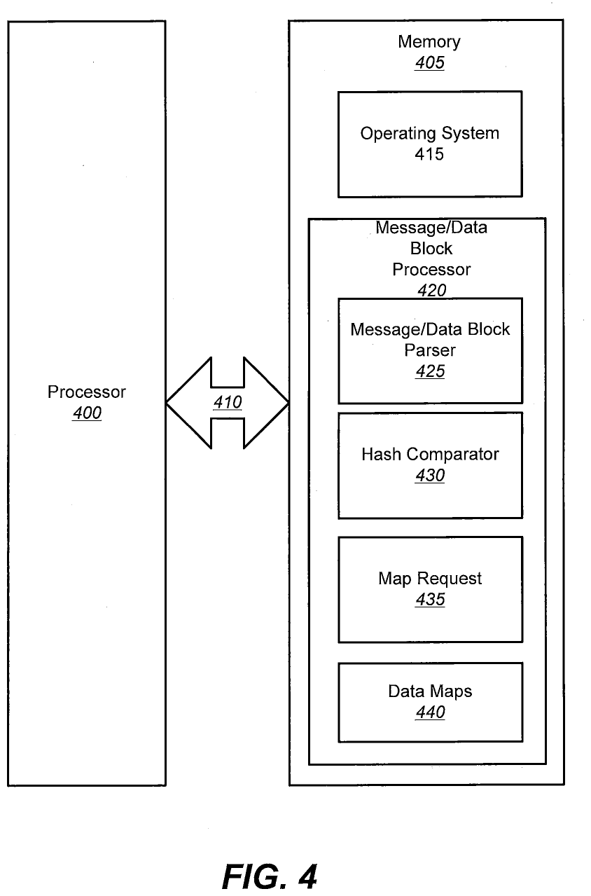

FIG. 4 illustrates a processor 400 and memory 405 that may be used in embodiments of data processing systems, such as the computer systems and/or data processing systems 110, 120, and 130 of FIG. 1 and the data processing system 300 of FIG. 3, respectively, for resolving different data block formats between software instances in accordance with some embodiments of the inventive subject matter. The processor 400 communicates with the memory 405 via an address/data bus 410. The processor 400 may be, for example, a commercially available or custom microprocessor. The memory 405 is representative of the one or more memory devices containing the software and data used for resolving different data block formats between software instances in accordance with some embodiments of the inventive subject matter. The memory 405 may include, but is not limited to, the following types of devices: cache, ROM, PROM, EPROM, EEPROM, flash, SRAM, and DRAM.

As shown in FIG. 4, the memory 405 may contain two or more categories of software and/or data: an operating system 415 and a message/data block processor module 420. In particular, the operating system 415 may manage the data processing system's software and/or hardware resources and may coordinate execution of programs by the processor 400. The message/data block processor module 420 may comprise a message/data block parser module 425, a hash comparator module 430, a map request module 435, and a data maps module 440.

The message/data block parser module 425 may be configured to receive a message for a receiving computer program instance and parse or decode the fields of a data block in the message using one or more data maps stored in the data maps module 440 that correspond to the received message's identification or message type. Similarly, the message/data block parse module 425 may be configured to decode the fields of a data block stored in persistent storage using one or more data maps stored in the data maps module 440.

The hash comparator module 430 may be configured to cooperate with the message/data block parser module 425 to parse or decode the fields in a received message and/or data block. In some embodiments, the hash comparator module 430 may compare the hash value that was received along with the message and is associated therewith with the hash values stored in the data maps module 445. The data maps module 440 may comprise hash values for each of the data maps stored in the data maps module 440. If the hash comparator module 430 determines a match between one of the hash values stored in the data maps module 440 and the hash valued associated with the received message, then this match is communicated to the message/data block parser module 425 to allow the message parser module to select the data map corresponding to the matching hash value from the data maps module 440 to be used in parsing or decoding the received message. In similar fashion, the hash comparator module 430 may be configured to compare the hash value associated with a data block stored in persistent storage with a hash value associated with the same type of data block used by the current computer program level. If these hash values differ, then the message/data block parser may retrieve the data map associated with the data block stored in persistent storage from the data maps module 440 to parse or decode the data block.

The map request module 435 may be configured to request the data map corresponding to the received message from the computer program instance that sent the message responsive to an indication from the hash comparator module 430 that none of the hash values in the data maps module 440 match the hash value associated with the received message.

Although FIG. 4 illustrates hardware/software architectures that may be used in computer systems and/or data processing systems, such as the computer systems and/or data processing systems 110, 120, and 130 of FIG. 1 and the data processing system 300 of FIG. 3, respectively, for resolving different message data block and/or persistent memory data block formats between software instances in accordance with some embodiments of the inventive subject matter, it will be understood that the present invention is not limited to such a configuration but is intended to encompass any configuration capable of carrying out operations described herein.

Computer program code for carrying out operations of computer systems and/or data processing systems discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the computer systems and/or data processing systems 110, 120, and 130 of FIG. 1, the data processing system 300 of FIG. 3, and the hardware/software architecture of FIG. 4, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

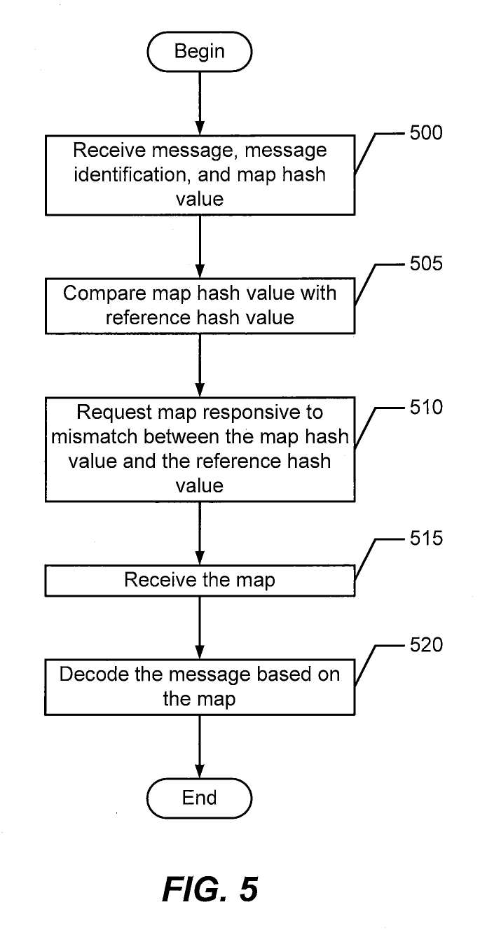

The data processing apparatus of FIGS. 1-4 may be used to facilitate resolving different data block formats between software instances according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 306 coupled to the processor 308 and the memory 405 coupled to the processor 400 include computer readable program code that, when executed by the respective processors, causes the respective processors to perform operations including one or more of the operations described herein with respect to FIGS. 5-7.

FIGS. 5-7 are flowcharts that illustrate operations for resolving different message data block and/or persistent data block formats between software instances in accordance with some embodiments of the inventive subject matter. Referring now to FIG. 5, operations begin at block 500 where a first computer program instance running on the computer system and/or data processing system 110, for example, receives a message, a message identification, and a data map hash value at block 500 from a second computer program instance running on computer system and/or data processing system 120. The first and second computer program instances are different from each other—Levels 1.0 and 1.2, respectively. The first and second computer program instances may be different application program levels and/or different operating system levels. At block 505, the message/data block parser module 425 running on the computer system and/or data processing system 110 cooperates with the hash comparator module 430 to compare the hash value received with the message and associated with the computer program Level 1.2 with a reference hash value for that message associated with the computer program Level 1.0. It is determined at block 510 that there is a mismatch between the hash values compared at block 505 indicating that the two computer program Levels 1.0 and 1.2 use different formats for this particular message identification or type. Moreover, there are no other hash values in the data map module 440 corresponding to this message identification or message type, which are associated with other maps previously received for this message identification or message type. Thus, at block 510, the map request module 435 requests the data map from the computer program running on the computer system and/or data processing system 120 for the message that was received. The data map is received at block 515 and the message/data block parser 425 uses the received map at block 520 to parse or decode the fields in the data block in the received message using the received data map. As described above, each field is identified through a field name and one or more attributes. The attributes may include, but are not limited to, length, an offset within the message, a data format, a justification, pad bytes, and/or character encoding (e.g., ASCII, EBCDIC, UNICODE, etc.). The data map may further identify whether a field is repeating and, if so, a number of repetitions for the repeating field.

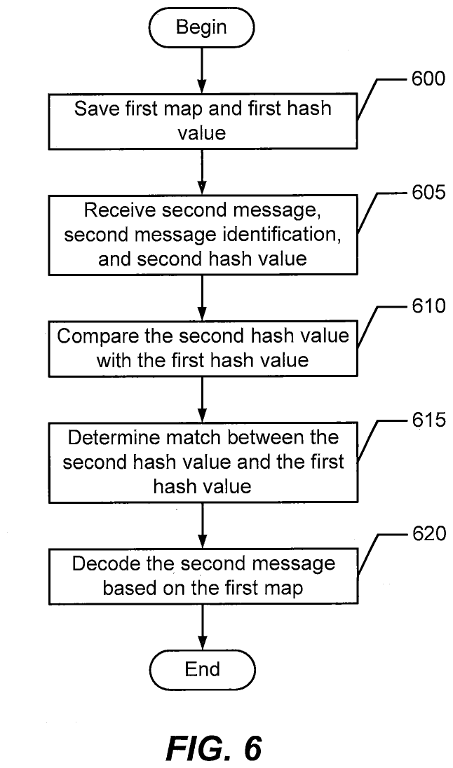

To avoid requesting the data map for this particular message format from other message senders in the future, the message/data block parser 425 may save the data map and associated hash value in the data maps module 440. Such embodiments are illustrated, for example, in the operations of FIG. 6. Referring now to FIG. 6, operations begin at block 600 where the message/data block parser module 425 saves the data map received from the Level 1.2 computer program running on the computer system and/or data processing system 120 and the associated hash value as a first data map and a first hash value in the data maps module 440. The Level 1.0 computer program running on the computer system and/or data processing system 110 receives a second message with a second message identification or type, and a second hash value from a Level 2.0 computer program running on the computer system and/or data processing system 130 at block 605. At block 610, the message/data block parser module 425 running on the computer system and/or data processing system 110 cooperates with the hash comparator module 430 to compare the first hash value saved at block 600 with the second hash value received with the second message and associated with the computer program Level 2.0. At block 615, a determination is made that the first and second hash values match. This indicates that Level 1.2 of the computer program and Level 2.0 of the computer program use the same format for this particular message identification or message type, while Level 1.0 of the computer uses a different format for this particular message identification or message type. At block 620, the message/data block parser 425 may use the first map saved at block 600 and corresponding to the data map received from the Level 1.2 computer program previously to parse or decode the newly received message from the Level 2.0 computer program. Thus, even though the format for the particular message identification or type received from the Level 2.0 computer program is different from the format the Level 1.0 program uses for this particular message identification or type (i.e., results in different hash values), because the Level 1.0 computer program has already parsed or decoded this format type previously, the data map was saved thereby obviating the need for the Level 1.0 computer program to request the data map again. Computer programs, therefore, may build up a library of data maps, which are identified by their associated hash values for the different message formats used across various computer program versions in an enterprise.

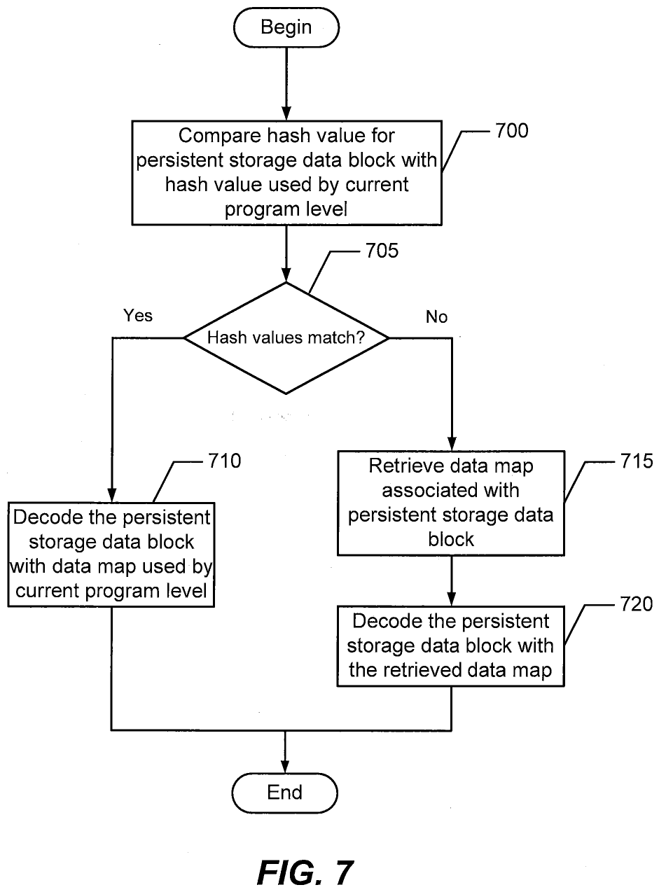

Referring now to FIG. 7, operations for accessing a data block in persistent storage begin at block 700 where the hash comparator module 430 of a computer program compares a hash value for the persistent storage data block with a hash value used by a current program level. As described above, a computer program associated with a first level may store a block of data, such as a file, for example, in persistent storage using a first data structure format. The computer program may change levels over time, however, such that the later level computer program may use a second data structure format for the persistent storage data block that is different than the first. The data maps for persistent storage data blocks for various computer program levels may be stored with the message data maps as part of the data maps module 440. When it is determined that the values match at block 705, the message/data block parser 425 of the computer program decodes the persistent storage data block with the data block used by the current program level at block 710. Otherwise, when the hash values do not match, the map request module 435 of the computer program retrieves the data map associated with the persistent storage data block at block 715 and the message/data block parser module 425 uses the retrieved data map to decode the persistent storage data block at block 720.

According to some embodiments of the inventive subject matter, when a computer system or data processing system is updated with a new computer program level that includes a change to one or more message formats and/or data blocks, e.g., data structures, communication with other computer systems and/or data processing systems will result in the updated computer program sending data map(s) to the other systems enabling them to decode the message(s). The data map need only be sent once to a destination as the receiving system will save the data map and retrieve the data map for parsing and decoding a received message based on the hash value associated with the data map, which is transmitted with future messages. Moreover, as other systems are updated to a same level that a first system had been updated to previously, they will be less likely to have to send a data map to a destination system as the other systems in the enterprise may have already saved the data map(s) associated with the new level due to previous communication with the first system that was updated. Thus, embodiments of the inventive concept may allow computer systems and/or data processing systems to be updated to new computer program levels on a staggered schedule allowing for disparity between levels while maintaining a communication capability between the systems. Moreover, some embodiments allow the systems to learn the new message formats used when changing computer program levels while reducing the number of times a data map need be transmitted between systems as a hash value is sufficient to retrieve a data map associated with another computer program level for parsing and decoding a message once it has been seen for the first time. In addition, data maps may be associated with persistent storage data blocks allowing access to data blocks stored using a first format that may not be understood by computer programs on different levels than the computer program that originally saved the data block in persistent storage.

Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing by a processor:
receiving a message, a message identification, and a hash value of a map specifying a layout of the message;
comparing the hash value with a reference hash value associated with the message identification;
requesting the map responsive to a mismatch between the hash value and the reference hash value;
receiving the map; and
decoding the message based on the map.

2. The method of claim 1, wherein the map identifies a plurality of fields in the message and further identifies, for each of the plurality of fields, a field name and a plurality of field attributes.

3. The method of claim 2, wherein the plurality of field attributes comprises a length, an offset within the message, a data format, a justification, pad bytes, or character encoding.

4. The method of claim 3, wherein the map further identifies one of the plurality of fields that is repeating and a number of repetitions for the one of the plurality of fields that is repeating.

5. The method of claim 1, wherein the map is a first map and is associated with a first computer program level; and
wherein the reference hash value is of a reference map associated with a second computer program level that is different from the first computer program level.

6. The method of claim 5, wherein the first computer program level comprises a first application program and the second computer program level comprises a second application program that is different from the first application program.

7. The method of claim 5, wherein the first computer program level comprises a first operating system and the second computer program level comprises a second operating system that is different from the first operating system.

8. The method of claim 5, wherein the message, message identification, and hash value are a first message, first message identification, and first hash value, respectively, the method further comprising:
saving the first map and the first hash value;
receiving a second message, a second message identification, and a second hash value of a second map specifying a layout of the second message, the second message identification and the first message identification being the same;
comparing the second hash value with the first hash value;
determining a match between the second hash value and the first hash value; and
decoding the second message based on the first map.

9. The method of claim 5, wherein the first map is generated during a compilation of the first computer program level and the reference map is generated during a compilation of the second computer program level.

10. A system, comprising:
a processor; and
a memory coupled to the processor and comprising computer readable program code embodied in the memory that is executable by the processor to perform operations comprising:
receiving a message, a message identification, and a hash value of a map specifying a layout of the message;
comparing the hash value with a reference hash value associated with the message identification;
requesting the map responsive to a mismatch between the hash value and the reference hash value;
receiving the map; and
decoding the message based on the map;
wherein the map identifies a plurality of fields in the message and further identifies, for each of the plurality of fields, a field name and a plurality of field attributes;
wherein the map is a first map and is associated with a first computer program level; and
wherein the reference hash value is of a reference map associated with a second computer program level that is different from the first computer program level.

11. The system of claim 10, wherein the plurality of field attributes comprises a length, an offset within the message, a data format, a justification, pad bytes, or character encoding.

12. The system of claim 11, wherein the map further identifies one of the plurality of fields that is repeating and a number of repetitions for the one of the plurality of fields that is repeating.

13. The system of claim 10, wherein the first computer program level comprises a first application program and the second computer program level comprises a second application program that is different from the first application program.

14. The system of claim 10, wherein the first computer program level comprises a first operating system and the second computer program level comprises a second operating system that is different from the first operating system.

15. The system of claim 10, wherein the message, message identification, and hash value are a first message, first message identification, and first hash value, respectively, the operations further comprising:
saving the first map and the first hash value;
receiving a second message, a second message identification, and a second hash value of a second map specifying a layout of the second message, the second message identification and the first message identification being the same;
comparing the second hash value with the first hash value;
determining a match between the second hash value and the first hash value; and
decoding the second message based on the first map.

16. A computer program product comprising:
a tangible computer readable storage medium comprising computer readable program code embodied in the medium that is executable by a processor to perform operations comprising:
receiving a message, a message identification, and a hash value of a map specifying a layout of the message;
comparing the hash value with a reference hash value associated with the message identification;
requesting the map responsive to a mismatch between the hash value and the reference hash value;
receiving the map; and
decoding the message based on the map.

17. The computer program product of claim 16, wherein the map identifies a plurality of fields in the message and further identifies, for each of the plurality of fields, a field name and a plurality of field attributes.

18. The computer program product of claim 17, wherein the plurality of field attributes comprises a length, an offset within the message, a data format, a justification, pad bytes, or character encoding.

19. The computer program product of claim 18, wherein the map further identifies one of the plurality of fields that is repeating and a number of repetitions for the one of the plurality of fields that is repeating.

20. The computer program product of claim 16, wherein the map is a first map and is associated with a first computer program level; and
wherein the reference hash value is of a reference map associated with a second computer program level that is different from the first computer program level.
